(19) United States
(12) Patent Application Publication
(10) Pub. No.: US 2021/0121987 A1
(43) Pub. Date: Apr. 29, 2021

(54) DUAL-LASER CUTTING MACHINE AND CUTTING METHOD TEHREOF

(71) Applicant: LITZ HITECH CORPORATION, Taichung City (TW)

(72) Inventor: WEI-HWA HU, Taichung City (TW)

(21) Appl. No.: 16/663,345

(22) Filed: Oct. 25, 2019

(51) Int. Cl. B23K 26/38; B23K 26/08; B23K 26/10

(52) U.S. Cl. CPC B23K 26/38; H01S 3/2232; B23K 26/10; B23K 26/0876

(57) ABSTRACT

A dual-laser cutting machine includes a cutting machine having a machine body. The bottom of the machine body is provided with a bottom base mounting a working platform for fixing a workpiece. The machine body mounts a compound cutter base, which can move relative to the machine body to adjust the relative position between the compound cutter base and the working platform. The compound cutter base mounts a UV laser generator and a CO₂ laser generator. First, fix the workpiece. Then, use the UV laser generator to emit the low-power UV nano laser to punch the predetermined cutting line of the workpiece to create holes thereon. As the holes are very close to each other, there are many cracks formed therebetween. Afterward, use the CO₂ laser generator to emit the CO₂ laser in defocus status to cut the path formed by the holes.

### BACKGROUND OF THE INVENTION

### 1. Field of the Invention

The present invention relates to a machining technology, in particular to a cutting machine installed with two types of laser generators so as to simplify production processes, increase efficiency and improve the accuracy of machinery processing.

### 2. Description of the Prior Art

Brief introduction of the currently available laser cutting process is as follow:

(I) Fix a workpiece on a machine A; the machine A cuts the surface of the workpiece by a femtosecond laser generator (10⁻¹⁵ sec) or a picosecond laser generator (10⁻¹² sec) so as to create a predetermined cutting line thereon;

(II) Move the workpiece to a machine B; the machine B cuts the predetermined cutting line by a CO₂ laser generator to generate dilataional stress, such that the workpiece ruptures along the predetermined cutting line. Then, the cutting process is finished.

As the currently available laser cutting process generates a lot of thermal stress, so the thermal stress should be removed after the cutting process is finished. Meanwhile, as the cut surface of the workpiece is not easy to achieve the desired smoothness, it is necessary to grind the cut surface in order to satisfy the requirements in smoothness.

Thus, the shortcomings of the currently available laser cutting process are as follows:

1. The femtosecond laser generator and the picosecond laser generator are very expensive.

2. The femtosecond laser generator and the picosecond laser generator are very large, so it is not easy to integrate the cutters into the cutting machine.

3. The costs of repairing the femtosecond laser generator and the picosecond laser generator are very high.

4. The energies of the femtosecond laser generator and the picosecond laser generator cannot be transmitted via optical fibers, but should be transmitted via many lens sets, which results in high energy loss.

5. The lens sets tend to get dirty during the cutting process of the cutting machine.

6. It is necessary to remove the thermal stress of the workpiece or grind the workpiece after the cutting process is finished.

7. The cutting machine should be returned to the original manufacturer for repairing, which will result in a long-term shutdown in the customer's factory.

Obviously, it is necessary to further improve the shortcomings of the currently available laser cutting process.

### SUMMARY OF THE INVENTION

The primary objective of the present invention is to provide a cutting/fine-grinding process designed for workpieces made of brittle materials, such as glass, which can create cracks in expectable directions to simplify the cutting process instead of taking the workpieces to another machine for further processing. The present invention can significantly increase accuracy and reduce the processing time.

Another objective of the present invention is to use an ultrasonic grinder installed on the same machine to remove the cracked edges of the workpieces according to actual requirements, and create shapes in high precision or special shapes, such as bevel, chamfer, etc.

For achieving the foregoing objectives, the present invention provides a dual-laser cutting machine, which includes a cutting machine, a working platform, a compound cutter base, an ultraviolet (UV) laser generator and a CO₂ laser generator. The cutting machine includes a machine body and the bottom of the machine body is provided with a bottom base. The working platform is mounted on the bottom base for fixing a workpiece. The compound cutter base is mounted on the machine body and can move relative to the machine body so as to adjust the relative position between the compound cutter base and the working platform. The UV laser generator is mounted on the compound cutter base and punches the surface of the workpiece by the low-power UV nano laser in high density to create holes thereon and form cracks between the holes. The CO₂ laser generator is mounted on the compound cutter base and cutting a path formed by the holes by the CO₂ laser in defocus status, such that the cracks between the holes are ruptured after slightly inflate due to heat.

The cutting method implemented by the aforementioned dual-laser cutting machine includes the following steps:

(a) Fixing the workpiece;

(b) Emitting the low-power UV nano laser by the UV laser generator to punch the predetermined cutting line of the workpiece in high density to create the holes thereon; as the holes are close to each other, the area between any two adjacent holes are full of the cracks;

(c) Emitting the CO2 laser in defocus status by the CO2 laser generator to cut the path formed by the holes, whereby the cracks between the holes are ruptured after slightly inflate due to heat; and

(d) Taking off the workpiece.

According to the above description, the advantages, compared with the currently available laser cutting process, of the present invention includes:

1. The cost of the combination of the laser generators according to the present invention is only 1/7 of the cost of the currently available laser cutting process.

2. The combination of the laser generators according to the present invention are of small size, so can be easily integrated into the cutting machine.

3. The repair cost of the combination of the laser generators according to the present invention is low.

4. The dual-laser according to the present invention can be directly repaired in the customer's factory.

5. It does not need to remove the thermal stress from the finished products processed by the machine and the process according to the present invention and the shapes of the finished products already achieve high accuracy.

6. The low-power UV nano laser emitted by the UV laser generator can be transmitted via optical fibers without energy loss.

7. The machine and the process according to the present invention do not have the problem that the lens set tend to get dirty.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a perspective view of a dual-laser cutting machine in accordance with one embodiment of the present invention;

FIG. 2 is a schematic view of the working status of the dual-laser cutting machine punching in high density in accordance with one embodiment of the present invention;

FIG. 3 is a schematic view of a working status of the dual-laser cutting machine cutting off a workpiece in accordance with one embodiment of the present invention;

FIG. 4 is a flow chart of a cutting method of the dual-laser cutting machine in accordance with one embodiment of the present invention;

FIG. 5 is a schematic view of a working status of the dual-laser cutting machine grinding by oscillation in ultra-high frequency in accordance with one embodiment of the present invention.

FIG. 6 is a flow chart of a cutting method of the dual-laser cutting machine grinding by oscillation in ultra-high frequency in accordance with one embodiment of the present invention.

### DETAILED DESCRIPTION OF THE PREFERRED EMBODIMENT

The following description is about embodiments of the present invention; however it is not intended to limit the scope of the present invention.

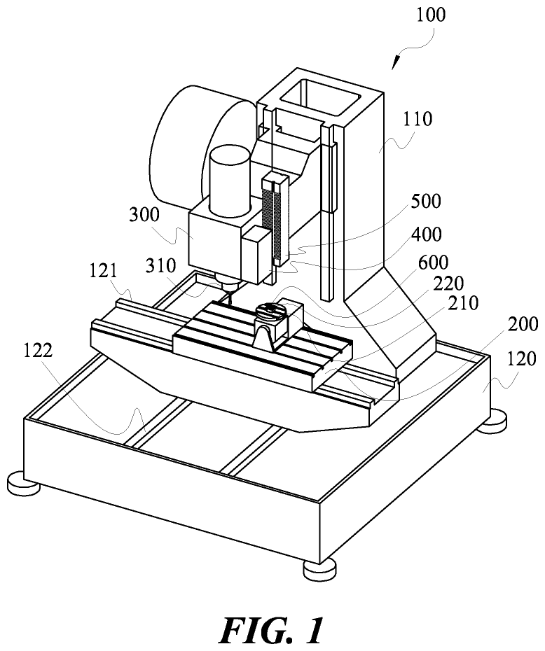

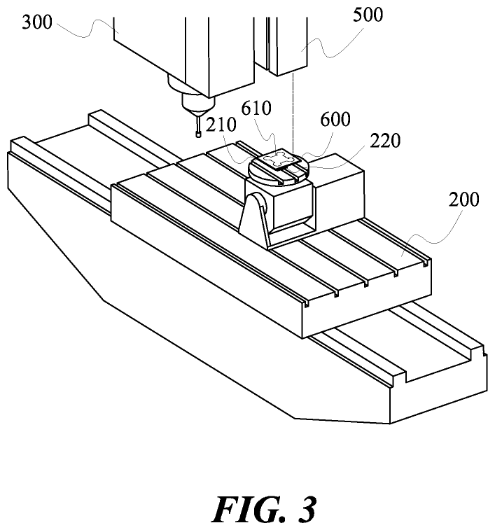

Please refer to FIG. 1 to FIG. 3, which show a dual-laser cutting machine according to one embodiment of the present invention. The dual-laser cutting machine includes a cutting machine 100, a working platform 200, a compound cutter base 300, an ultraviolet (UV) laser generator 400 and a CO₂ laser generator 500.

The cutting machine 100 includes a machine body 110 and the bottom of the machine body 110 is provided with a bottom base 120. The bottom base 120 is used to mount the cutting machine 100 and the assemblies thereon.

The working platform 200 is mounted on the bottom base 120 for fixing a workpiece 600.

The compound cutter base 300 is mounted on the machine body 110, such that the compound cutter base 300 can move relative to the machine body 110 so as to adjust the relative position between the compound cutter base 300 and the working platform 200.

The UV laser generator 400 is mounted on the compound cutter base 300. The UV laser generator 400 punches the surface of the workpiece 600 by the low-power UV nano laser in high density to create holes 610 thereon and form cracks (not shown in the drawings) between the holes 610. The low-power UV nano laser emitted by the UV laser generator 400 can be transmitted via optical fibers without energy loss.

The CO₂ laser generator 500 is also mounted on the compound cutter base 300 and cutting the path formed by the holes 610 by the CO₂ laser in defocus status, such that the cracks between the holes 610 are ruptured after slightly inflate due to heat.

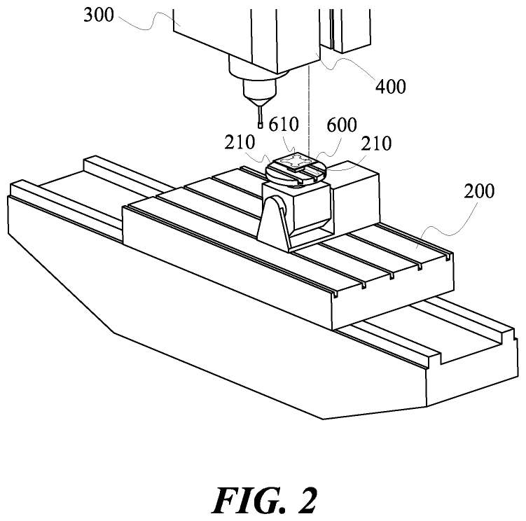

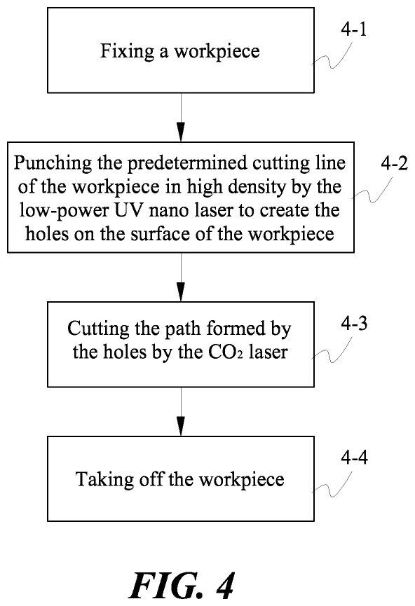

Please refer to FIG. 2 to FIG. 4; the cutting method of the dual-laser cutting machine according to one embodiment of the present invention includes the following steps:

4-1: Manually or automatically place the workpiece 600 on the working platform 200 and fix the workpiece 600;

4-2: Emitting the low-power UV nano laser by the UV laser generator 400 to punch the predetermined cutting line of the workpiece 600 in high density to create the holes 610 thereon; the holes 610 are close to each other, such that the area between any two adjacent holes 610 are full of the cracks, which is a desired physical phenomenon.

4-3: Emitting the CO₂ laser in defocus status by the CO₂ laser generator to cut the path formed by the holes 610 along the predetermined cutting line, such that the cracks between the holes 610 are ruptured along the predetermined cutting line after slightly inflate due to heat; and

4-4: Taking off the workpiece 600 after the above cutting process is finished.

The most obvious characteristic of the above cutting method is to use the low-power UV nano laser to create the holes 610 in dense distribution and make the cracks be full of the areas between the holes 610, such that the holes 610 and the cracks can be precisely distributed along the predetermined cutting line. In this way, the cut surface of the workpiece 600 can be in high smoothness and accuracy. It is usually not necessary to further grind the cut surface of the workpiece 600 unless the smoothness of the cut surface is extremely high.

Please refer to FIG. 1; the bottom base 120 is provided with rails 121, 122 so as to move the workpiece 600. The bottom of the working platform 200 leans against the rails 121, 122 and moves along the rails, 121, 122 to adjust the relative position between the workpiece 600 and the compound cutter base 300.

If the user needs to implement a 5-axis machining process, the working platform 200 can be further provided with a rotational working table 210. The workpiece 600 is fixed on the rotational working table 210 and the rotational direction of the rotational working table 210 can be adjusted.

The working platform 200 or the rotational working table 310 can be provided with a clamping fixture 220 for fixing the workpiece 600 and adjusting the position of the workpiece 600. The clamping fixture 220 can be fixed on the working platform 200 or the rotational working table 310 by various ways. In the embodiment, the clamping fixture 220 includes a vacuum sucking disk, which can be fixed on the working platform 200 or the rotational working table 310 via vacuum absorption; however, the above structure is just for illustration instead of limitation.

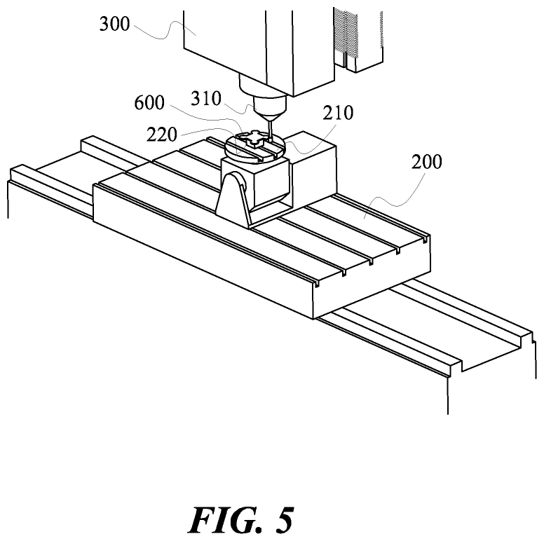

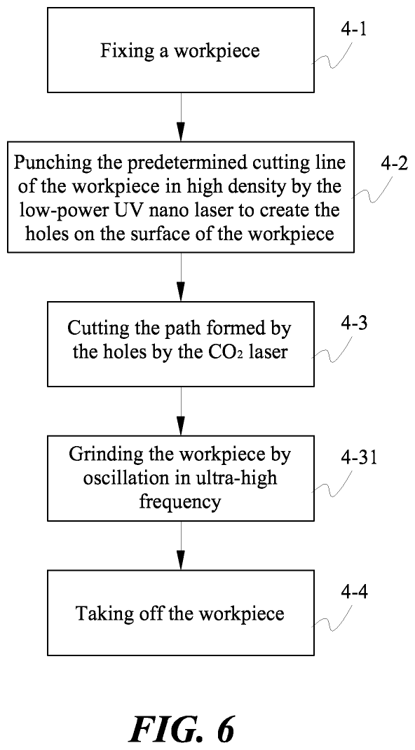

Please refer to FIG. 5 and FIG. 6; the compound cutter base 300 is provided with an ultrasonic grinder 310. If it is necessary to conform to ultra-high precision requirements, the process can proceed to Step 4-31 after Step 4-3. In Step 4-31, the ultrasonic grinder 310 can be used to grind the scraps, generated after the workpiece 600 are cut, by oscillation in ultra-high frequency in order to further modify the size and the surface of the workpiece 600 to achieve higher precision.

The above disclosure is related to the detailed technical contents and inventive features thereof Those skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A dual-laser cutting machine, comprising:
a cutting machine, comprising a machine body, and a bottom of the machine body being provided with a bottom base;
a working platform, mounted on the bottom base for fixing a workpiece;
a compound cutter base, mounted on the machine body and being able to move relative to the machine body so as to adjust a relative position between the compound cutter base and the working platform;
an ultraviolet (UV) laser generator, mounted on the compound cutter base and punching a surface of the workpiece by a low-power UV nano laser in high density to create holes thereon and form cracks between the holes; and
a CO₂ laser generator, mounted on the compound cutter base and cutting a path formed by the holes by a CO₂ laser in defocus status, whereby the cracks between the holes are ruptured after slightly inflate due to heat.

2. The dual-laser cutting machine of claim 1, wherein the bottom base comprises a rail, and a bottom of the working platform leans against the rail and moves along the rail to adjust a relative position between the workpiece and the compound cutter base.

3. The dual-laser cutting machine of claim 1, wherein the working platform is provided with a rotational working table, the workpiece is fixed on the rotational working table, and a rotational direction of the rotational working table is able to be adjusted.

4. The dual-laser cutting machine of claim 1, wherein the working platform is provided with a clamping fixture for fixing the workpiece and adjusting a position of the workpiece.

5. The dual-laser cutting machine of claim 1, wherein the compound cutter base is provided with an ultrasonic grinder for grinding scraps, generated after the workpiece are cut, by oscillation in an ultra-high frequency.

6. A cutting method using the dual-laser cutting machine of claim 1, comprising:
(a) fixing the workpiece;
(b) emitting the low-power UV nano laser by the UV laser generator to punch a predetermined cutting line of the workpiece in high density to create the holes thereon, wherein the holes are close to each other, such that an area between any two adjacent holes are full of the cracks;
(c) emitting the CO₂ laser in defocus status by the CO₂ laser generator to cut the path formed by the holes, whereby the cracks between the holes are ruptured after slightly inflate due to heat; and
(d) taking off the workpiece.

7. The cutting method of claim 6, wherein when a step (c) is finished, cut surfaces of the workpiece are ground to further modify a size and the surface of the workpiece.
